(19) United States
(12) Patent Application Publication
(10) Pub. No.: US 2019/0279467 A1
(43) Pub. Date: Sep. 12, 2019

(54) System and Interface for Skill-Based Squares Game

(71) Applicant: Richard Saunders, Newton, MA (US)

(72) Inventor: Richard Saunders, Newton, MA (US)

(21) Appl. No.: 16/299,229

(22) Filed: Mar. 12, 2019

Related U.S. Application Data
(60) Provisional application No. 62/641,805, filed on Mar. 12, 2018.

(51) Int. Cl. G07F 17/32

(52) U.S. Cl. CPC G07F 17/3258; G07F 17/3276; G07F 17/3223

(57) ABSTRACT

The present disclosure provides systems and methods of the play of skill-based games of squares that maintains player engagement, and in contrast to existing sports fan games, provide opportunities for less avid sports fans to participate enjoyably. In accordance with aspects and embodiments, weighted point values are assigned to squares based on the desirability of the squares. In certain cases, the desirability of squares may be determined by a computerized system having a central hub and processor in communication with players via the internet.

### FIELD OF THE INVENTION

The present disclosure relates to skill based games and more particularly, provides systems and methods that enable users to play a skill-based games of squares. The methods and systems of the disclosure improve upon existing squares games in that even when played for money, they are, in many instances, legal, maintain player engagement, and in contrast to existing sports fan games, provide opportunities for less avid sports fans to participate enjoyably.

### DESCRIPTION OF RELATED ART

Grid-type games that make use of squares are known in the art by several names, including but not limited to Football Squares, Super Bowl Squares, Square Grids, a Ten Square Game, Square Pool or just “Squares”. In their most common format, a ten by ten square grid is drawn on a blank sheet of paper or other medium such that a grid is generated containing 100 “empty” squares. The name of a college or professional sports team (most often a football team) is assigned to the x-axis over the grid, that is, along the top of the paper. Similarly, the name of the opposing team is assigned to the y-axis and labeled down the left side of the grid. A grid of this type is typically generated for game play prior to the commencement of an upcoming contest, for example, prior to the commencement of the Super Bowl. This type of game is commonly played by players that are avid football fans and for example, also participate in fantasy football leagues, as well as party-goers who may not even watch the Super Bowl, but enjoy the festivities surrounding the match.

In traditional squares games, the game host or operator solicits numerous players to randomly place their names in these squares—oftentimes the squares are “sold” to players who hope to win a profitable monetary return. Other times, players may play just for fun or to win donated prizes without the player paying any entry fees. Some players may be allowed to purchase or otherwise claim multiple squares. “Ownership” of more squares increases a player's chance of winning.

Once all of the squares have been sold or otherwise owned or claimed by players, the game operator will randomly draw sets of numbers (from zero through nine) along the top and left side axes of the grid, corresponding to the columns and rows, such that each of the 100 squares on the grid has a unique two-digit designation deriving from its spatial relationship (intersection point) on the grid. For each square, the number on the top of the column is the first designation and the number on the left side of the row it resides in is the second number. For example, a given square in the grid that has a 7 on the x-axis and a 3 on the y-axis has a square designation of (7, 3). The 7 correlates to the home team and the 3 relates to the opponent or away team. At the end of the sporting contest in question (or some other predetermined interval in the contest, which may be, for example, at the end of a football quarter, or at half time), if the game score corresponds to the square 7, 3, the player who owns that square wins. In the event the actual game scores are double digit numbers (as is often the case in football), only the second digit is counted as far as the square game is concerned. So if the sports game ended with the home team winning 7 to 3 or 17 to 23 etc. then the (7, 3) square would be declared the winner and receive whatever prize or prizes the game operator is offering.

Most operators employ a scheme where four prizes are awarded, using the score in place at the end of each quarter of the football game (if football is the sport used as the underlying basis). The prize amount is generally determined by the cost players are charged to own a square. For example, if players were charged $25 per square, a total prize pool of $2,500 would be available to be awarded to one player or split between whatever number of winners are declared. Some operators take a share or cut of the prize pool and pay out the remainder. In every instance when players are charged an entry fee, the fee is the same for all of the squares.

These prior art games of squares, as normally played, suffer from two main problems. First, because these games are considered “games of chance”, they are not legal in many situations and jurisdictions when played for money. Second, players often suffer from immediate dissatisfaction and disappointment when the square or squares they own draw number sets they perceive as “low value” due to the relative infrequency that they end up as winners. Thus, there is a need to develop a squares-based game that overcomes these drawbacks by both requiring skill and enhancing player satisfaction. Additionally, existing games tailored to engage sports fans, such as fantasy sports games and leagues, often require a high degree of knowledge of the teams and players involved in each and every match. This discourages less devoted sports fans from participating in these types of games/leagues. Thus there also is a need for games corresponding to sporting events and sports seasons that more casual sports fans can participate in and enjoy alongside their more ardent counterparts.

### SUMMARY

In accordance with aspects and embodiments, methods and systems for the playing of a skill-based games of squares are provided.

In accordance with aspects and embodiments, a method of playing a game of squares is provided, the method comprising generating a game board having a 10×10 grid of squares, the game board having an x-axis and a y-axis, wherein the x-axis, labeling each square with a number from 0-9 in sequential order on the x-axis and labeling each with a number from 0-9 in sequential order on the y-axis, labeling the x-axis with a first sports team and labeling the y-axis with an opposing sports team, assigning each square a point value; and providing game players with an equal amount of starting bank points. In accordance with embodiments, players purchase squares for their point values using bank points, and the assigned point value of a given square is proportional to the desirability of the square. The desirability of the square is related to the x and y coordinates of the square, and a player wins when the player has purchased a square having x-and y-coordinates that are equal to the last digits of a score of a sporting event between the first sports team and the opposing team at a given time during or at the conclusion of the event. Players may win monetary or non-monetary prizes, and the game can be extended to last for the duration of entire sports seasons, or longer, or alternatively, can be played for a single sporting match.

In accordance with embodiments, a computerized squares game system is disclosed, the system comprising a web-based computerized hub having central processor and including board generating module and a play module, wherein the web-based computerized hub generates at least one game board having a 10×10 grid of squares, the at least one game board having an x-axis and a y-axis, wherein the x-axis is labeled with a first sports team and the y-axis is labeled with an opposing team, and wherein each square is labeled 1-10 in sequential order and each square being assigned a point value. The system has plurality of players each in communication with the web-based computerized hub and given by the web-based computerized hub an equal amount of starting bank points, wherein the plurality of players interact with a graphical user interface to purchase squares for their point value with their bank points, and their purchases are received by the play module of the web-based computerized hub.

In accordance with embodiments, square has a designation in accordance with its x and y coordinates and the assigned point value of a given square is proportional to the desirability of the square, wherein desirability is determined by the x and y coordinates of the square. In accordance with embodiments, wherein the web-based computerized hub determines desirability of a square by aggregating information received by the processor. Like in the methods disclosed, a player wins when the player has purchased a square having x- and y-coordinates that are equal to the last digits of a score of a sporting event between the first sports team and the opposing team at a given time during or at the conclusion of the event. In accordance with embodiments of the computerized system, the plurality of players playing the squares game are remotely in communication with one another via the internet.

### BRIEF DESCRIPTION OF THE DRAWINGS

FIG. 1 is a squares game board in accordance with aspects and embodiments; and

FIG. 2 is a web-based squares game system in accordance with aspects and embodiments.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The present disclosure provides an improved system and method for existing squares games based on chance. In accordance with aspects and embodiments, a squares game is provided that is a game of relative skill. The present systems and methods of playing squares games can thus be played openly and legally for money or prizes in many more jurisdictions than games of chance enjoy.

The systems and methods of squares games disclosed can alternatively be played for fun, enjoyment and bragging rights without money or prizes being involved. The elements introduced in the present disclosure add significantly to the complexity of the game and the disclosed squares game involves a greater level of player participation, data analysis, decision making, strategizing and planning, which is in marked contrast to the unskilled squares games of chance known in the art. These features, which necessitate increased player participation, advantageously result in enhancing player engagement, interest in game play, and satisfaction with game play.

In accordance with aspects and embodiments, the disclosed systems and methods for squares games may further improve player interest and satisfaction with game play by eliminating both the blind-draw and pure chance aspects of square games and instead allows contestants to choose their own number sets. Thus, in accordance with embodiments, players are thus not disappointed by continually losing out by the luck of the draw and only getting numbers and squares with long odds of winning.

In accordance with embodiments, the systems of the present disclosure use a methodology that still however result in both “good” and so-called “bad” number sets. To make so-called “bad” number sets attractive choices, that is, to encourage players to select number choices that are (or are perceived to be) less likely to win, each number set is assigned a “point value”. The best number sets are assigned higher point values, that is, they are only obtainable at a premium cost, and the “worst” number sets, those that appear less frequently in a given game situation, are assigned lower point values and can be obtained by the player at a significant point discount. By weighting given number sets, all number sets may be chosen with relatively equal frequency, depending on the player's preference to purchase “good” sets at premium, or take their chances with less desirable sets but do so at a discount.

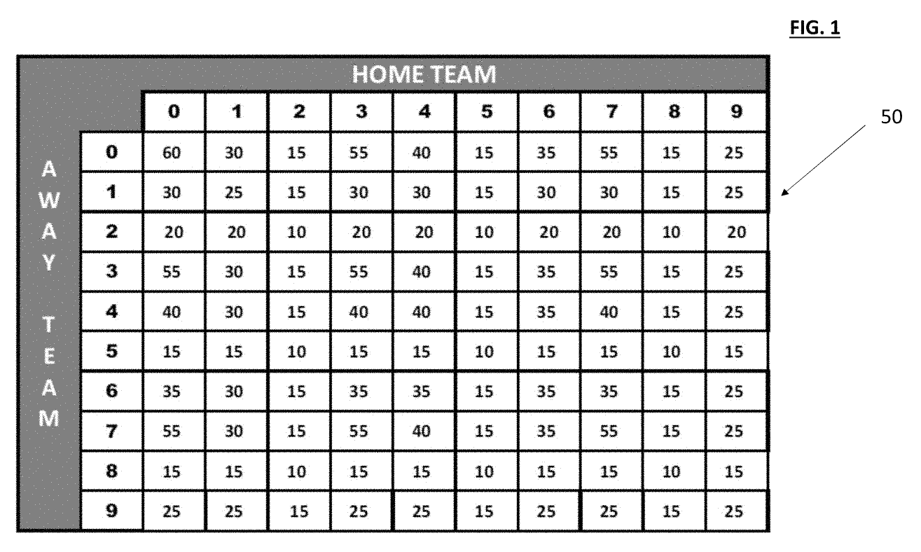

In one embodiment of the squares game system of the present disclosure, a squares game may be initiated prior to the commencement of a single sporting event, and the duration of the game may correspond only to the length of the single sporting event, and a winner will be declared after the event ends. Alternatively and in accordance with embodiments of the squares game system of the present disclosure, the squares game may span an entire football season and may have several individual games corresponding to single football matches within the season. The duration of the squares game may thus correspond to the length of the regular football season and may exclude playoffs. The football season may, for example, correspond to the games of a particular team within a football league, for example, one team within the National Football League, and each individual game board, i.e, the grid, may correspond to a match that the selected NFL team plays against opponents throughout the season. In some embodiments, the squares game may be played for fun and bragging rights only, that is, without the exchange of any money, or alternatively, may be played for real currency. In the non-monetary model, all players may be given a starting bank of a set value of points, for example, 2,500 points at the beginning of the football season. In the case of monetary play, the “buy in” for the season may, for example, be $250 dollars, and each dollar may equate to 10 points, such that each player has a starting bank of 2,500 points. Regardless of whether or not play is for money or not, players allowed a maximum budget of points per game, which may, for example, be 125. A player may choose to spend that budget for up to a maximum of five squares per game without exceeding the 125 point budget. Players who, during the course of the season, lose all 2,500 of their bank points are eliminated from the squares game. This forces or entices players to carefully consider their spending choices. It should be noted that to ensure proper game play, only one square of a game board may be owned or claimed by a single user. If other users desire to claim a particular square, it must be claimed on a different game board. In one embodiment, the squares game is computerized and a computer operating the system of the present invention may automatically generate a new game board once all squares of an earlier game board, such as that shown at 50 of FIG. 1, have been sold or otherwise claimed. The new game board may correspond to another match the selected NFL team is set to play against another opponent.

In accordance with a squares game that spans the duration of a football season, for each match, there may be one or more winners during the match, though they are not necessarily the overall winner or winners of the entire season-long game. For example, when a player's square wins during a given match, a portion of the total points on the board for that match may be deposited into the player's bank. At the end of the season, the player with the most points in their bank may be declared the winner.

FIG. 1 shows a representative squares game board 50 that may be offered for a match during the squares game described above. As can be seen in FIG. 1, each square contains within it a different number. These numbers correspond to the point values that each square costs. Thus, in accordance with the example provided where a player has a maximum budget of 125 points per match and can purchase no more than 5 squares per match, the player must strategically select which squares they wish to purchase. Square (0, 0) is the most expensive square on the board and is offered for 60 points. Square (8, 8) is one of the least expensive squares, and is offered for 10 points. The desirability of these squares, and whether or not a player purchases these squares, may depend on their evaluation of the teams and players playing the match for which the game board 50 represents.

That is, using statistical analysis, the game becomes one of relative skill where players maximize their chances of winning by spending their point budget wisely. For instance, evaluating the players involved in a match prior to selecting squares may impact the squares that are most desirable. Square (0, 0) in FIG. 1 is a winning square when neither team scores points (and/or when both teams have scores ending in zero). Referring to the scenario where neither team scores points, this square is particularly desirable if it is known that both teams playing have extremely strong defenses and are known to not give up any points. This square becomes even more desirable if one or both teams have correspondingly weak offenses that are less likely to be able to score points when faced with a strong defense. It will be appreciated that this type of information may be readily obtainable to even a novice sports fan. However, more in-depth evaluation of the team members and teams of a match may provide players with information they feel is not represented by the point values (cost) of squares on the game board.

For example, in a football game where one or both of the field goal kickers are having a poor season, a player may decide that this increases the odds that a so-called bad number, like 2, 6 or 8 will win, rather than a number like 3 or 0. Referring again to FIG. 1, this may make square (8, 8), which has one of the lowest point values (cost), particularly attractive to a player. Similarly, if a player learns that one of the field goal kickers was injured or benched before the game, certain squares may become more valuable to that player than they are “priced” on the game board.

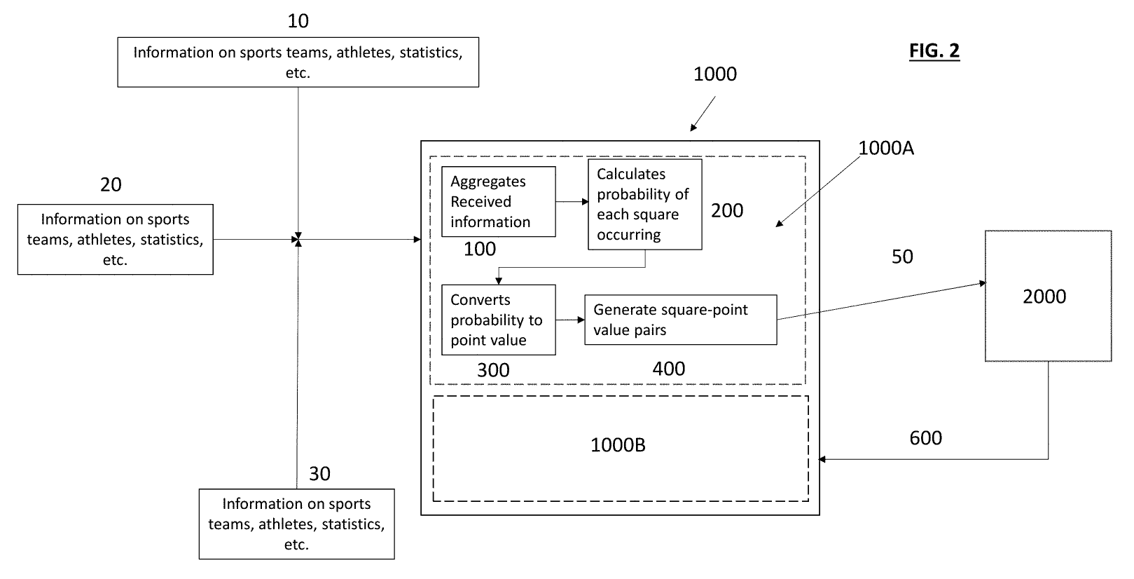

In accordance with aspects and embodiments and referring to FIG. 2, a web-based computerized system 1000 may be used to generate squares game boards 50 for play and web based system 1000 may interface with a network of players 2000. Web-based system 1000 may have game board module 1000A and play module 1000B. Modules are used herein to refer to combinations of programming and operations stored within the memory to allow a computer to carry out the required functions, receive/store inputs, and provide outputs. Game board module 1000A may receive information from one or more sources 10, 20, and 30 related to a given sporting match. Discrete pieces of information from sources 10, 20 and 30 may indicate that the match for which web-based system 1000 is generating game board 50 is between football teams known to have strong defensive lines and poor offenses. Module 1000A aggregates the individual pieces of information received into usable information 100. Information 100 may then be used to calculate the probabilities 200 that a given square on game board 50 will be a winning square. In other embodiments, desirability may be tracked based on all games being played on the system, such that other games may drive up or down the price of a particular square. For example, if a player is injured and will not play before a game, the point values for certain squares may change dynamically based on the trends indicated by a plurality of different games being played on the system and the squares being acquired. This allows a computerized embodiment of this disclosure to provide dynamic weighting (or “pricing”) of the various squares. Module 1000A may then convert the calculated probabilities into corresponding point values 3000 and assign point values 300 to the corresponding squares to create a square-point value combination 400, and output the point value-square combination. This solves the problem of the existing squares game by using a computer to set and adjust square values to compensate for their respective likelihood of winning. Game board module 1000A then outputs game board 50, as shown for example in FIG. 1, to network of players 2000. Network of players 2000 receive game board 50 on a graphical user interface displayed on a computer connected to the internet that receives information from web-based computerized system 1000. Network of players 2000 interact with game board 50 via a graphical user interface of their computers in networked communication with the computerized system to make selections about game play, and their game play selection inputs 600 are communicated back to computerized system 1000. Game play selection inputs 600 are received by the play module 1000B of system 1000.

Advanced players who study the statistics as sports seasons unfold will develop strategies in an attempt to gain whatever large or slim edge they can over their competitors and may attempt to purchase squares they believe are more valuable than priced by the computerized system. Game players will thus have to determine not only the best ways to spend their point budget for each game but will have to evaluate if they agree with each square's pricing and value.

In accordance with aspects and embodiments, the computerized system disclosed may allow for multiple different sporting event selections to be made across a single squares game platform. For example, a given player may play both a football squares game and a hockey squares game simultaneously. The computerized system may provide an interface via a web browser or any other known means where a player can view the squares board and see which squares he or she owns. The interface may further provide updated game scores and other information that may enhance the player's experience.

In accordance with aspects and embodiments, the computerized system disclosed may further aggregate a network of players for game play by being in networked communication with a plurality of computers operated by a plurality of players. Such a system may allow players to form private leagues to play squares games and may, for example, allow the player setting up the league, the league master, to invite only their friends into the league. The league master may further be allowed to designate if the league is playing for money, and if so, the amount of money required to buy-in to the league. The computerized system may further accept money from league members and disperse money accordingly. In accordance with aspects and embodiments, the system may charge a fee when players play with money. The system may also allow players to set up non-monetary leagues. The computerized system may further provide an interface where league masters can customize the terms of league play by selecting the initial bank value given to each player, the maximum budget a player can spend per match, and the maximum number of squares a player can purchase per match. As such, settings and operational parameters may be stored in a computer memory.

In accordance with embodiments, the computerized system may further facilitate play between players that are unknown to one another. That is, the system may set up public leagues with preset parameters that any player can join. The system may offer a plurality of leagues having different parameters and corresponding to different sports and different teams within each sport. The system may also offer games that correspond to single events, such that a player can play for just a single sporting event without having to commit to playing for an entire season.

The present novel system takes a game previously played on terms of pure chance and turns it into a game of relative skill and solves the problem with existing squares games of certain squares, which are assigned by luck of the draw, are much more or less likely to win despite a same initial wager by the players. Players are given the opportunity to spend more or less for given squares depending on computerized perceived desirability, which the player can then determine if it comports with the player's evaluation of the desirability of the square and the potential winnings available should they purchase the square. Players further must determine whether and/or when they should play one, two, three, four or five squares in a single game. Evaluating the available squares, the cost of the available squares, and their cost relative to the player's calculated desirability of those squares, requires statistical evaluation and strategy.

Similar to fantasy sports games, luck still may play a factor into the game and anyone can win, but over the course of thousands of trials, players with consistently smart and well-reasoned choices will influence and increase their odds of success over those who make selections in less-considered or random fashion. To this end, the game is attractive to both seasoned sports enthusiasts and casual fans.

The operation of the present system may be implemented on a computerized system or on a game board. In computerized embodiments, the system may be in communication with a network allowing multiple computerized interfaces to communicate to allow networked game play. The system may be implemented by an interface of a first user computer which is operable to electronically receive requests and other inputs for game play access and game play selection—both for particular games and for the selected squares/outcomes of the particular selected games. In a particular embodiment, a processor is coupled to the interface and is operable to determine available games in which a user may select or “buy” a square or squares for a particular sporting event. The processor may cause the interface to display one or more available square layouts for one or more sporting events, and options such as squares to select. This display may be in the form of a graphical representation of the table board of the game, such as that shown in the figures. The processor may then cause graphical representations on the interface to be changed upon receipt of an input selecting the particular square or squares that the user selects. Inputs or gestures of the present system may include, but are not limited to mouse clicks, touch screen taps, voice input, keyboard input, and the like. Interfaces may include, but are not limited to monitors, touch screens, mouse input, keyboard input, voice inputs, and the like in connection with a display monitor. For example, an indicator such as a color change, marker, or the like in a selected square may be displayed by the graphical display based on an input received. Program instructions to cause the processor to carry out these processes may be stored on a memory of the computer. Similarly, received inputs and instructions by the user interface may also be stored on this memory.

As noted, the above steps may be carried out by a first user computer. Typically, other user computers are in networked communication with either a server (central computer) or with the first user computer. In such embodiments, additional users may use computers and computer interfaces to provide selection inputs through gesture inputs as well. The system processor(s) may then cause the graphical interfaces to provide displays based on the selection inputs of the additional users. These displays may be provided to each interface of each networked user computer. Further, the inputs corresponding to the selected square or squares may cause the processor of at least the server or first computer to record, in a memory, the selections by the user(s), as well as causing the interfaces to display a notification of receipt of the selections.

Upon the update of various points of the sporting event being tracked by a particular game, the processor may be programmed to provide an update through the graphical user interface. Updates may include identification of a winner, probabilities of who will win based on a score of the sporting event and time left, and the like.

What is claimed is:

1. A method of playing a game of squares, the method comprising:
generating a game board having a 10×10 grid of squares, the game board having an x-axis and a y-axis;
labeling each square with a number from 0-9 in sequential order on the x-axis and labeling each with a number from 0-9 in sequential order on the y-axis;
labeling the x-axis with a first sports team and labeling the y-axis with an opposing sports team,
assigning each square a point value; and
providing game players with an equal amount of starting bank points.

2. The method of claim 1, wherein players purchase squares for their point values using bank points.

3. The method of claim 2, wherein the assigned point value of a given square is proportional to a desirability of the square.

4. The method of claim 3, wherein the desirability of the square is related to the x and y coordinates of the square.

5. The method of claim 4, wherein the assigned point values are generated by a computerized system.

6. The method of claim 2, wherein a player wins when the player has purchased a square having x- and y-coordinates that are equal to a last digits of a score of a sporting event between a first sports team and an opposing team at a given time during or at the conclusion of the sporting event.

7. The method of claim 6, further comprising the step of providing the player a monetary prize.

8. The method of claim 6, further comprising the step of providing the player a plurality bank points.

9. The method of claim 6, wherein the duration of a game is longer than a single sporting event.

10. A game system comprising:
a plurality of players each having equal amounts of starting bank points,
a game board having a 10×10 grid of squares, the game board having an x-axis and a y-axis, wherein the x-axis is labeled with a first sports team and the y-axis is labeled with an opposing team, and wherein each square is labeled 1-10 in sequential order;
each square being assigned a point value;
wherein each of the plurality of players purchase squares for the assigned point value with their provided bank points.

11. The game system of claim 10, wherein each square has a designation in accordance with its x and y coordinates.

12. The game system of claim 11, wherein the assigned point value of a given square is proportional to a desirability of the square, wherein desirability is determined by the x and y coordinates of the square.

13. The game system of claim 12, wherein a player wins when the player has purchased a square having x- and y-coordinates that are equal to a last digits of a score of a sporting event between a first sports team and an opposing team at a given time during or at a conclusion of the event.

14. The game system of claim 13, wherein the assigned point values of squares are generated by a computerized system.

15. The game system of claim 14, wherein the computerized system generates assigned point values by aggregating information received about the first sports team and the opposing sports team.

16. A computerized squares game system comprising:
a web-based computerized hub having central processor and including board generating module and a play module, wherein the web-based computerized hub generates at least one game board having a 10×10 grid of squares, the at least one game board having an x-axis and a y-axis, wherein the x-axis is labeled with a first sports team and the y-axis is labeled with an opposing team, and wherein each square is labeled 1-10 in sequential order and each square being assigned a point value;
a plurality of players each in communication with the web-based computerized hub and given by the web-based computerized hub an equal amount of starting bank points, wherein the plurality of players interact with a graphical user interface to purchase squares for the assigned point value with their bank points, and the player purchases are received by the play module of the web-based computerized hub.

17. The game system of claim 16, wherein each square has a designation in accordance with its x and y coordinates and the assigned point value of a given square is proportional to a desirability of the square, wherein desirability is determined by the x and y coordinates of the square.

18. The game system of claim 17, wherein the web-based computerized hub determines desirability of a square by aggregating information received by the processor.

19. The game system of claim 18, wherein a player wins when the player has purchased a square having x- and y-coordinates that are equal to a last digits of a score of a sporting event between a first sports team and an opposing team at a given time during or at a conclusion of the event.

20. The game system of claim 19, wherein the plurality of players are in communication with one another via the internet.
